(19) United States
(12) Patent Application Publication
(10) Pub. No.: US 2006/0146842 A1
(43) Pub. Date: Jul. 6, 2006

(54) Programmable transmit wave shaping for 10 BASE-T ethernet controller

(75) Inventors: Thomas S. David, Austin, TX (US); Paul Highley, Austin, TX (US)

Correspondence Address: HOWISON & ARNOTT, L.L.P, P.O. BOX 741715, DALLAS, TX, 75374-1715, US

(73) Assignee: Silicon Laboratories Inc.

(21) Appl. No.: 11/029,304

(22) Filed: Jan. 5, 2005

(51) Int. Cl. H04L 12/28

(52) U.S. Cl. 370/401

(57) ABSTRACT

An ethernet controller includes analog circuitry for generating a transmit waveform representing transmitted data. A transmit waveform is generated responsive to a digital control signal provided by digital circuitry. The digital control signal is programmable to enable amplification of the transmit waveform.

### TECHNICAL FIELD OF THE INVENTION

The present invention relates to 10 BASE-T ethernet controllers, and more particularly, to a method for programmably shaping a transmit waveform of a 10 BASE-T ethernet controller.

### BACKGROUND OF THE INVENTION

Ethernet controllers have evolved from the original network card type systems that provided network speeds of 2 Mb/s to 10 Mb/s, 100 Mb/s and up to current speeds of 1,000 Mb/s. The 2 Mb/s network interface cards have all but disappeared. Most network interface systems, or Network Interface Cards (NIC), currently provide for all three of higher speeds, 10/100/1000 Mb/s. These are usually referred to as 10 BASE-T, 100 BASE-T, and 1000 BASE-T, the “T” referring to a twisted pair physical media interface, other interfaces providing for connection to optical fibers and the such. Each of the various configurations, at whatever speed, includes on an integrated circuit a media side circuit or Media Access Controller, the MAC, and a physical side circuit of physical layer, the PHY. The NIC is operable to provide timing and encoding/decoding for receiving data and transmitting data. Typically, when data is transmitted over the physical transmission line, such as an RJ45 twisted wire cable, data will be received by the NIC from a processing system and this data stored in a FIFO of some sort, encoded for transmission and then transmitted. For received data, the opposite operation occurs These are well known circuits and fairly complex. At higher speeds, the core processing circuitry basically requires Digital Signal Processing (DSP) capability. Further, each network card will have associated therewith a unique address, such that it is unique to all other address cards and can be disposed on any network regardless of what other cards are disposed on the network. This is for the purpose of uniquely identifying any network device that is disposed on the network apart from other network cards. To facilitate this, a large block of numbers was originally created for the Ethernet by a centralized standards body, which large number is considered to be an inexhaustible number.

10 BASE-T is one of several adaptions of the ethernet IEEE 802.3 standard for local area networks. The 10 BASE-T standard, also called twisted pair ethernet, uses a twisted pair cable to interconnect transceivers. The twisted pair cable has a maximum length of 100 meters. Cables in the 10 BASE-T system are interconnected with RJ-45 connectors. A star topology is common with twelve or more computers connected directly to a hub or concentrator. The 10 BASE-T system operates at 10 megabits per second and uses base band transmission methods. While the 10 BASE-T system has a maximum cable length of 100 meters, some implementations by users may require the use of cable lengths longer than 100 meters. In a normal 100 meter or less application, the nominal differential voltage on the twisted pair cable is 2.5 V. When lengths of 100 meters are exceeded, the differential voltage may drop below this 2.5 V level limiting communications over the cable. Thus, some manner for enabling the use of cables longer than 100 meters by controlling the waveform signals applied to the cables is desirable.

### SUMMARY OF THE INVENTION

The present invention disclosed and claimed herein, in one aspect thereof, comprises an ethernet controller consisting of analog and digital circuitry. The analog circuitry generates a transmit waveform which represents the transmitted data. The transmit waveform is generated responsive to a digital control signal provided by the digital controlled circuitry. The digital control signal is programmable to enable amplification of the transmit waveform as desired.

### BRIEF DESCRIPTION OF THE DRAWINGS

Further features and advantages will be apparent from the following and more particular description of the preferred and other embodiments of the invention, as illustrated in the accompanying drawings in which like reference characters generally refer to the same parts or elements throughout the views, and in which:

FIG. 1 illustrates an overall diagram of a 10 BASE-T ethernet network including a single ethernet cable;

FIG. 2 illustrates a block diagram of a network controller interfaced with a microcontroller that provides some functionality for interfacing with peripherals and a network interface card;

FIG. 3 is a top level block diagram of an ethernet controller;

FIG. 4 illustrates a logical block diagram of the ethernet controller;

FIG. 5 is a block diagram of an analog portion of a 10 BASE-T ethernet controller;

FIG. 6 is a block diagram illustrating the manner in which a digital controller provides programmable waveform shaping information to an IDAC within the analog portion of the 10 BASE-T ethernet controller; and

FIG. 7 illustrates a block diagram of the interface of the flash memory with the on-chip data, address and control buses;

FIG. 8 illustrates a diagrammatic view of the memory map of the on-board flash;

FIG. 9 illustrates a block diagram of the overall system associated with the present disclosed embodiment;

FIG. 10 illustrates a detailed diagram of the processor core and memory with the associated protected control logic;

FIG. 11 illustrates a diagrammatic view of the memory map for the restricted space and user space;

FIG. 12 illustrates an exemplary flowchart illustrating a processor between the user space and the restricted space;

FIG. 13 illustrates a diagrammatic view of a system using the protected memory of the present disclosure;

FIG. 14 illustrates a more detailed block diagram of a microprocessor core and memory with the protective logic interface;

FIG. 15 illustrates a detailed block diagram of one aspect of the protective logic;

FIG. 16 illustrates a block diagram of another embodiment of the protective logic;

FIG. 17 illustrates another embodiment of the protective logic; and

FIG. 18 illustrates an additional embodiment of the protective logic.

### DETAILED DESCRIPTION OF THE INVENTION

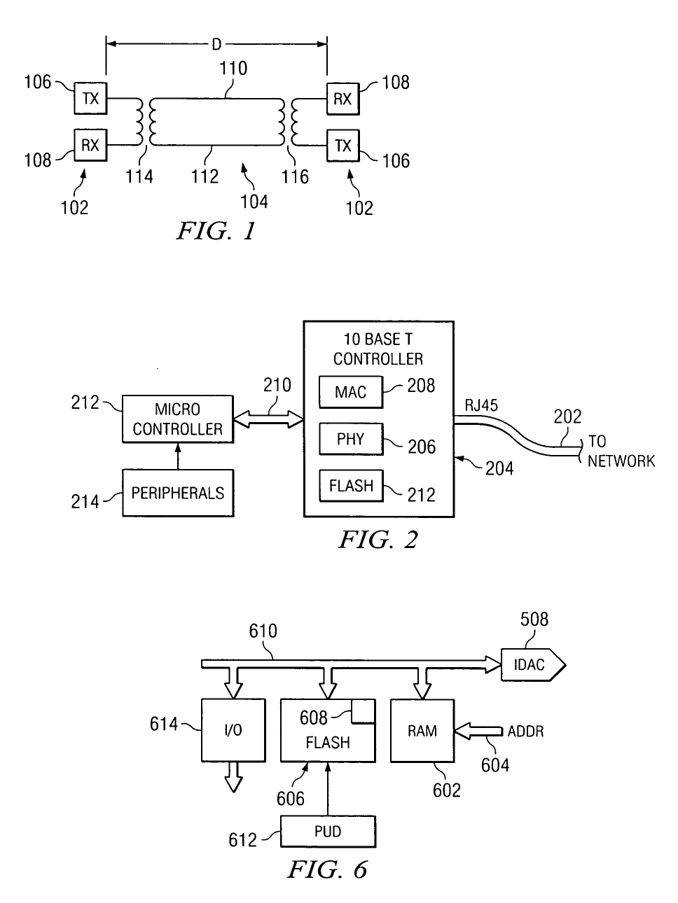

Referring now to the drawings, and more particularly to FIG. 1, there is illustrated the interconnection of a pair of 10 BASE-T ethernet controllers 102 interconnected by an ethernet cable 104. Each controller 102 includes a transmitter portion 106 and a receiver portion 108. The ethernet cable 104 consists of a twisted pair of wires 110 and 112. A twisted pair cable consists of two independently insulated wires twisted around one another. The use of two wires twisted together helps to reduce cross talk and electromagnetic conduction. The controllers 102 are interfaced with the cable 104 at transformers 114 and 116, respectively. Data may be transmitted from the transmitter 106 over the cable 104 to a receiver 108 at the receiving transceiver. The twisted pair cable 104 has a maximum length D of 100 meters. For cable lengths greater than 100 meters, distortion of the received signal may make communications between controllers 102 impossible.

Referring now to FIG. 2, there is illustrated a diagrammatic view of a network controller that is operable to be disposed on a network. The network appliance is basically interfaced to a network with some type of physical cable 104. In an Ethernet environment, this would be an RJ45 cable. However, there could be other types of networks, even a wireless network. The physical cable is interfaced with a network interface controller 102. This controller has associated therewith a physical layer section 206 that is labeled PHY. This provides for the encoding/decoding functions, the timing functions, etc., that are necessary to interface with the network through the particular physical media. For example, in an RJ45 cable, this is well known but different than for an optical cable, which would require a different set of timing rules, etc. The PHY 206 handles this encoding/decoding and timing. On the opposite side of the controller 102 is provided a media interface device 208, referred to as a Media Access Controller (MAC). Thus, data can be received on an input databus 210 from the media side, processed through the MAC 208 and the PHY 206 for transmission to the physical cable 104. Conversely, data can be received from the physical cable 104, processed by the PHY 206 and MAC 208 and output on the databus 210. The databus 210 is connected to a microcontroller 212, which is a device that provides minimal processing in this application. It has a digital side to interface with the bus 210 and possibly some analog circuitry, such that the microcontroller 212 would constitute a mixed-signal device. The analog circuitry could interface with various analog peripherals 214, to sense environmental parameters, etc., for interface with the network. For example, this network appliance could be a thermostat, wherein temperature were measured and control outputs provided that could be transmitted via the network to another network appliance such as a furnace controller, or the microcontroller 212 could interface with the furnace controller as a local peripheral and the network would merely provide remote monitoring and control of the thermostat. It should be noted that there are many applications that require a microcontroller that interfaces to a network for communication purposes and which network appliance would require a unique network address such that it is identifiable on a network. Further, although not disclosed herein, the network controller 104 could have a network address that was definable on an even larger network such as a global communication network (GCN) that is typically referred to as the Internet.

Most Ethernet controllers will typically require some type of external memory to provide for storage of configuration information that will be loaded automatically at power-up. Typically, an EEPROM will be utilized, since it is both programmable and nonvolatile. The controller 102 has built therein non-volatile flash memory 212 that provides two functions. First, it provides for storage of configuration information on-chip. Second, as will be described in more detail herein below, it provides additional external microcontroller memory to allow minimal functionality microcontrollers with little memory additional accessible storage space. Thus, the microcontroller 212, during the operation thereof, can access the flash memory 212 within the controller 102 for the purpose of obtaining information thereof such as configuration information and such, and any other information necessary. This basically takes a very unsophisticated microcontroller and provides additional capabilities thereto.

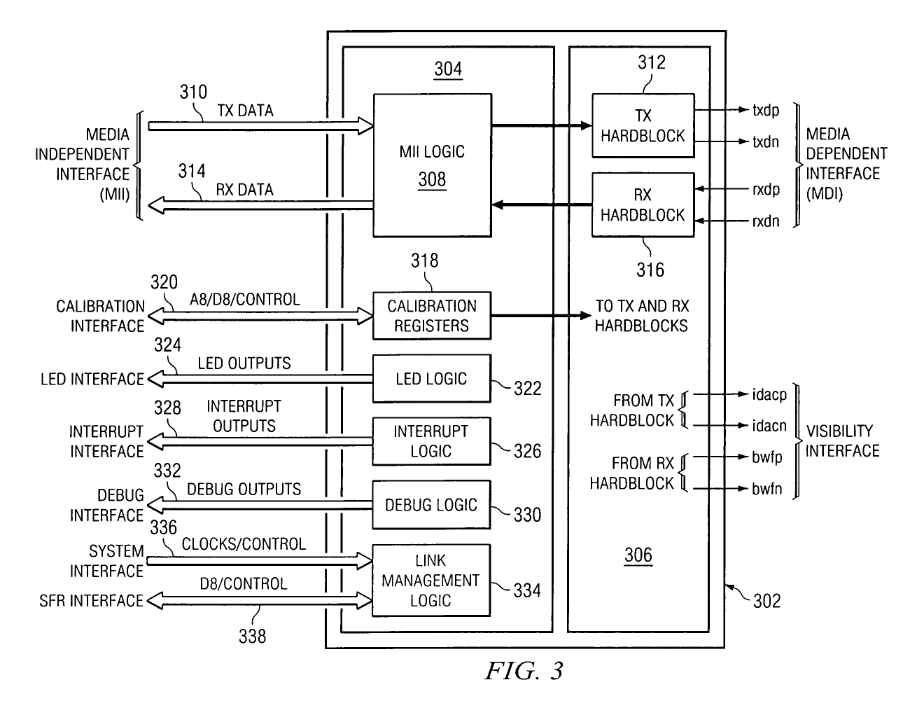

Referring now to FIG. 3, there is illustrated a top level block diagram of a 10 BASE-T ethernet controller 102. The 10 BASE-T ethernet controller 102 includes a digital logic portion 304 for generating the digital data necessary to transmit data over the ethernet cable 104 and an analog portion 306 for modulating the digital data into an analog waveform transmitted over the ethernet cable 104. Media independent interface (MII) logic 308 enables networks to use different physical devices operating over different media types. Transmit data 310 is provided to the media independent interface logic 308 and the digitized data is provided to the transmitter hard block 212 within the analog portion 306 of the ethernet controller 102. Likewise, the media independent interface logic 308 provides receive data 314 responsive to information received from the received hard block 316 within the analog portion 306. The media independent interface logic 308 utilizes the received transmit data to provide information for generating an output analog waveform generated within the transmitter hard block 312 representing the received data. Media independent interface logic 308 interprets the data representing the received analog waveforms and converts this into digital data that is provided as received data 314.

The calibration registers 318 receive address data and control information over the calibration interface 320. This information is provided to the transmit hard block 312 and the receive hard block 316 of the analog portion 306 to enable transmission and reception of the transmit and receive data. The LED logic 322 provides for the control of various LEDs within the ethernet controller 102 and provides visual indications to a user by LED outputs 224. When problem conditions arise on the ethernet transceiver requiring the stopping of transmission or reception of data, this type of operation is controlled by the interrupt logic 326. The interrupt logic 326 generates interrupt outputs that are provided to cease particular transmission or reception operations upon detection of an interrupt condition by the interrupt logic 326. The debug logic 330 is used for detecting programming errors within the ethernet controller 102. Debugging outputs 332 are provided to enable a user to determine bug conditions causing errors within the ethernet controller 102. The link management logic 334 controls the operation of the ethernet controller 102 and manages the transmission of data over the ethernet cable 104 interconnecting the ethernet controller 102 to other ethernet devices. The link management logic 334 utilizes clocks and control information 336 provided thereto to generate and receive data and control information 338.

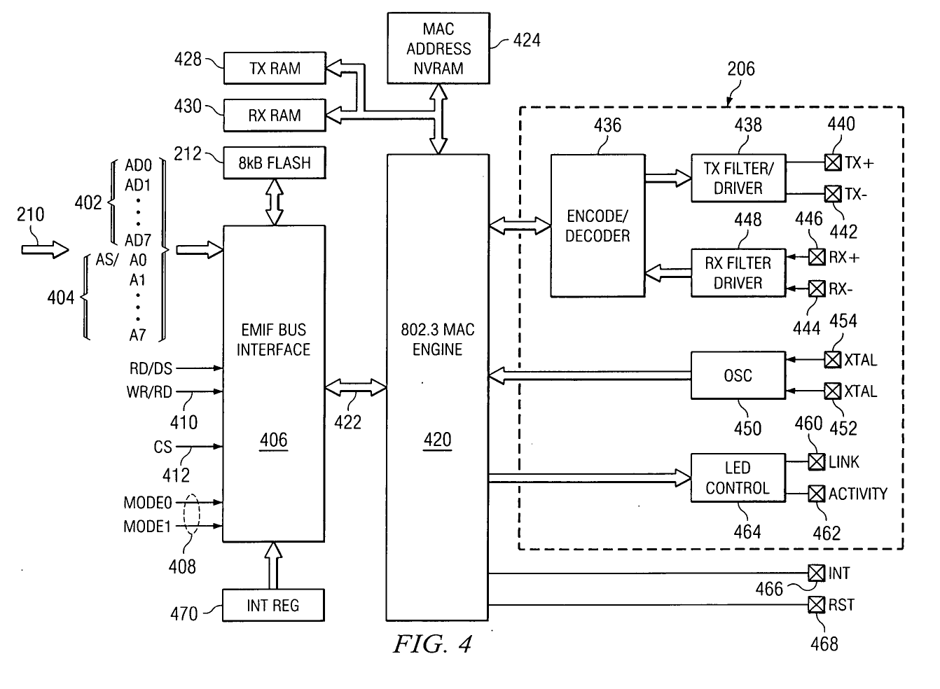

Referring now to FIG. 4, there is illustrated a block diagram of the network interface controller 102. This network interface controller 102 is operable at the 10 Mb/s operating rate, such that it is a 10 BASE-T device and can be completely realized on a single chip. In so doing, the entire network interface controller 102 can be fabricated on a single chip with the on-chip flash. There is provided a databus 410 that constitutes the interface between the microcontroller 412 and the network interface controller 102. There is provided in the network interface controller 102 a data interface to the databus 410 that provides for both multiplexed and non-multiplexed operations. For the multiplexed operation, there are provided eight address/data pins 402. For a non-multiplexed operation, there are provided eight additional address pins 404. In the non-multiplexed operation, the pins 402 would be data pins and the pins 404 would be address pins. This configuration for interfacing with a databus utilizes the External Memory Interface (EMIF) format. This is a fairly standard interface that is utilized on different manufacturers' parts, wherein each manufacturer may have a slightly different format. The EMIF interface is provided with a bus interface block 406 that is operable to support one or two different manufacturers' EMIF memory interface formats, these being selected for convenience purposes. Also, this will provide both multiplexed and non-multiplexed formats. These formats are selected by two mode pins 408 that allow for the selection between multiplexed and non-multiplexed operation and also provides for two different interface formats. Only one mode pin is required for selecting between two different third party formats. The bus bandwidth will provide sufficient throughput for the 10 BASE-T throughput with a transaction speed that is less than 300 ns/transaction. Reads and Writes to various memory locations and registers are performed through using various EMIF command-addresses. For example, a Read from the location “RX_AUTO_INCREMENT” will perform a Read from the current receive buffer and will update a receive FIFO pointer. A Read or a Write from a “non-command” location will assume the location is a register that will provide the register Read value, i.e., data, on the EMIF databus at the relevant time. There will be provided Read/Write commands on a pin 410, a chip select command on a pin 412 and other commands that are necessary. In general, any type of interface could be provided that would allow external access to memory on the chip by the microcontroller 412. There is provided the flash memory 412 that is interfaced with the EMIF bus interface block 406. There is also provided a Media Access Control (MAC) engine 420 that is fully compliant with IEEE 802.3 Ethernet Standard (ISO/IEC 8802-3, 1993). This will basically handle all aspects of the Ethernet frame, transmission and reception, including: collision detection, preamble generation detection, and CRC generation and tests. There may even be included various programmable features such as automatic re-transmission or collision and automatic padding of transmitted frames. The MAC engine 420 interfaces with the bus interface 406 through a bus 422. There will be provided a MAC address nonvolatile RAM 424 that interfaces with the MAC engine 420 for the operation thereof. This provides configuration information to the MAC for the operation thereof. Although illustrated as a separate memory location, the MAC address RAM 424 is basically part of the nonvolatile flash 412, albeit in an address location dedicated for storage of configuration information. There are also provided a 2 KB transmit RAM buffer 428 that is interfaced to the MAC engine 420 through a databus and a 4 KB receive RAM 430 that is interfaced to the MAC engine 420 through the databus. Data that is being transmitted will be stored in the transmit RAM 428 and data that is being received will be stored in the receive RAM 430 during the operation thereof.

The MAC engine 420 interfaces with the PHY 206. The PHY 206 includes an encoder/decoder 436 that is operable to receive data from the MAC engine 420 for encoding thereof and receive encoded data therefrom for transmission to the bus 410. Encoded data for transmission is output to a transmit filter/driver block 238 for transmission on two transmit terminals 440 and 442. Data is received on two separate wires at terminals 444 and 446. This configuration is for a physical RJ45 cable, in this disclosed embodiment, such that there are two dedicated transmit pins and two dedicated receive pins. They will be interfaced through a transformer to a transmission line. The received data, once received, is processed through a receive filter/driver block 448 for decoding of the data therein at the block 436. There is provided timing for the MAC engine with an oscillator 450 that typically will require an external crystal on pins 452 and 454.

Most Ethernet controllers will require, as part of the IEEE standard, LEDs that indicate that there is a link and an LED that indicates that there is activity. The link LED is connected to a pin 460 and the activity LED is connected to a pin 462, both pins 460 and 462 controlled by an LED control block 464, which is controlled by the MAC engine 420.

The MAC engine 420 is also operable to generate an interrupt on a pin 466 and receive a reset on pin 468. As such, the MAC 420 engine will be able to generate an interrupt to an external system that can utilize this interrupt to then access an interrupt register 470 for the purpose of determining what interrupt occurred. This interrupt register 470 represents two 8-bit registers.

In general, the receive interface is facilitated with the receive RAM 430, which is basically a 4K FIFO that can support up to eight Read packets. This 4K FIFO can be divided into a maximum of eight packet frames. The FIFO is written via hardware by the receive path of the MAC engine 420, and is read by software via the EMIF interface 406. The transmit interface is facilitated with the transmit RAM 428 that is a 2K single ported RAM buffer. This buffer will be written a byte at a time via the EMIF bus interface block 406 with the packet that is to be transmitted. Once the entire packet has been placed in this RAM 428, a “BEGIN_TX” bit is set which then begins a transmit session to the MAC engine 420. During transmission, a flag is set indicating that the transmit engine is busy. Once the transmission is complete, this bit will be cleared and an interrupt will be generated on the interrupt pin 466 indicating that the transmission has been completed. The transmit engine will support features such as transmitting a pause packet, applying back pressure (half duplex) and overriding the CRC and padding capabilities on a per packet basis. The packet based-transmission on collision, etc. is handled automatically with the MAC engine 420. Basically, transmission is facilitated by first writing the start address of the transmit packet (usually “x0000”) to an address register. This is followed by writing data to a TX_AUTO_INCREMENT register location which will place the data in the location pointed to by the address register. Thereafter, transmission is initiated by writing the start address to the address register and then writing a “1” to the “TX_start” bit in the transmit control register.

The flash 412 can be accessed via the EMIF bus interface 406 for Reads and Writes. There are provided some ADDRH/L registers that should first be written with the starting address. Thereafter, an auto-increment Read can be performed or a single-byte Write (or Read) can be performed. Flash mass erases are typically not permitted by the user. These are protected by a lock and key mechanism that will prevent a user from deleting information accidentally. Another lock and key mechanism also protects Writes. Once unlocked, back-to-back Writes to the flash will be possible. To unlock a Write operation, it is necessary to perform back-to-back Write operations to a particular address with some predefined data which is the “key.”

There are a number of flash interface registers that are contained in the bus interface. There is a FLASHLOCK register that is operable to perform Writes or page/mass erases with the address values A5, F1, which need to be written to this location consecutively. There is provided an INFOPGWR register that allows the performance of mass erases. To perform mass erases or to write to an information page, a code is required to be written consecutively to this location. There is provided a FLASH ERASE register which can allow for initiating a page erase or a mass erase. A FLASH STATUS register provides status information as to if the flash is having a page erase performed, being mass erased, a flash Write is occurring, the flash is busy or that the flash has been erased since the last reset. There is an ADDRH/L register that is an address register used to access the flash. To Read or Write flash, it is necessary to first write the address of the byte to be accessed in this location and then perform the auto-increment operation for Reads or the 1-byte operation for a Read or a Write, these being EMIF commands. With the auto-increment command, only the address of the first byte needs to be written, with subsequent Reads all incrementing this address.

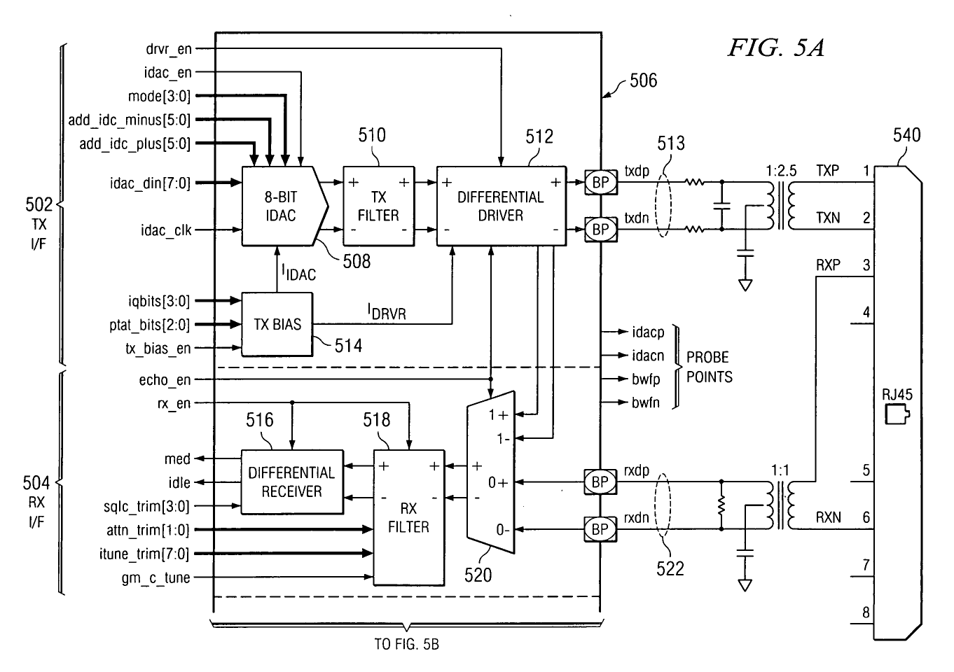

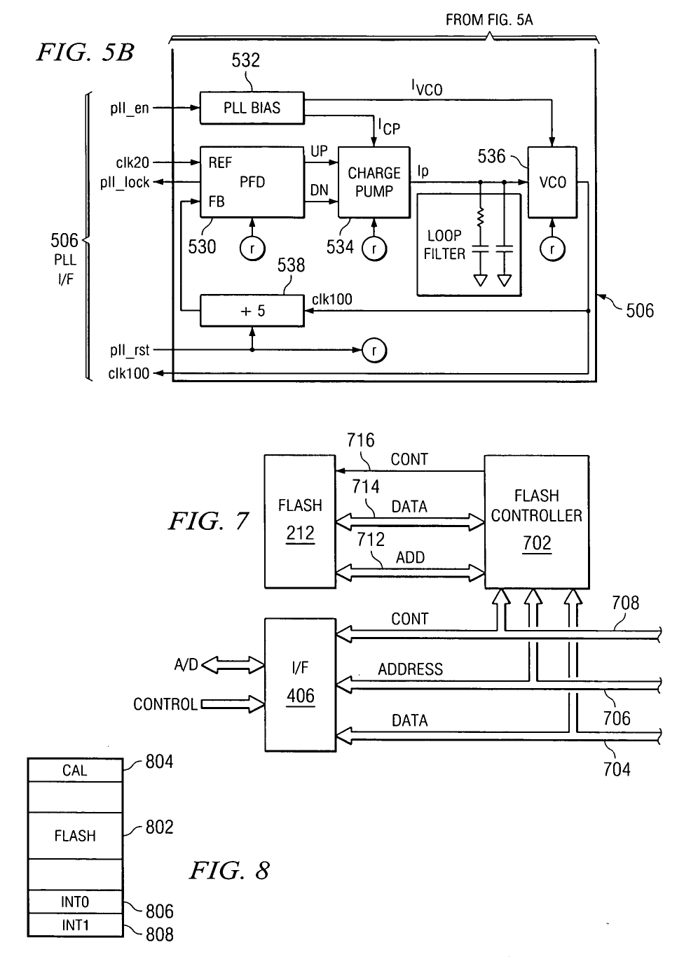

Referring now to FIG. 5, there is more fully illustrated the analog portion 306 (FIG. 3) of the ethernet transceiver 102. The analog portion 306 consists of a transmitter portion 502, a receiver portion 504 and a phase locked loop portion 508. The transmitter portion 502 consists of an 8-bit IDAC 508, a transmitter filter 510, a differential driver 512 and a transmitter bias circuit 514. The 8-bit IDAC 508 is responsive to the digital data input from the media independent interface logic 308 to convert the digital data signals into an analog current signal responsive thereto. The transmit filter 510 filters the signal from the IDAC 508 to a desired bandwidth. The differential driver 512 is a device containing two amplifiers for driving the generated signal over the twisted pair lines of the ethernet cable 104. The transmitter bias circuit 514 is used to bias the IDAC 508 and differential driver 512 responsive to input signals provided by the media independent interface 208.

The receive portion 504 contains a differential receiver 516, a receive filter 518 and a multiplexer 520. The received signals are received from the ethernet cable 104 over the receive pins 522. They are provided to a multiplexer 520 which multiplexes these signals with signals being transmitted from the transmitter section as provided by the differential driver 512 to the receive filter 518. The receive filter 518 filters the received signal and provides the received signal to a differential amplifier 516. The differential amplifier 516 amplifies the signal for provision to the digital portion 304 of the ethernet transceiver 102.

The phase locked loop 506 includes a phase detector 530 and phase locked loop bias circuit 532 connected to a charge pump 534. The charge pump 534 and phase locked loop bias circuit 532 are connected to a voltage controlled oscillator 536 having a feedback loop with the phase detector 530. A divide by five circuit 538 is placed within the feedback loop between the voltage controlled oscillator 536 and the phase detector 530. The first end of the ethernet cable 104 is connected to the transmitter pins 513 and the receiver pins 522. The other end of the ethernet cable 104 is connected to an RJ 45 connector 540 according to the IEEE 802.3 standard.

As mentioned previously, the normal length for the ethernet cable 104 is a maximum of 100 meters. However, certain applications for use by an individual may require that the ethernet cable be longer than 100 meters. In this case with existing ethernet controllers 102, the transmit wave provided by the ethernet controller 102 would be insufficient to provide the transmitted data to a receiving unit since the differential voltage across the twisted pair lines would be insufficient. In order to overcome this problem, a programmable transmit wave shaping functionality by the digital portion 304 of the ethernet transceiver 302 is necessary. By providing an amplified digital waveform information to the IDAC 508 of the analog portion 306 of the ethernet controllers 102, a waveform having a sufficient voltage differential may be generated on the ethernet cable 104 even over distances of greater than 100 meters.

Referring now to FIG. 6, programmable wave shaping information is provided by storing configuration data for creating an amplified waveform in a protected area 608 of FLASH memory 212. For cable lengths of 100 meters or more, the pulse shaping information is stored at location 608 in FLASH memory 212. During system startup, the power-up detecter (PUD) 602 causes the configuration data to be loaded from the protected area 608 into the RAM memory 602. The configuration data is preprogramed into the protected area 608 based on the length of cable being dealt with by the controller. When transmit wave information is sent to the IDAC 508 based upon whether a “1” or “0” data bit is being transmitted by the ethernet controller, this information is selected from the downloaded configuration information in the RAM memory 602 such that the transmit waveform will be of sufficient amplitude to enable the transmission of the “1” or “0” bit data. The data to be transmitted is moved between the flash memory 212, RAM memory 602 and IDAC 308 of the analog portion of the ethernet transceiver over a digital data bus 610. Using the above described system, the transmit waveform provided from the digital portion 304 of an ethernet controller may provide an amplified transmit waveform to be generated by the analog portion 306 of the ethernet controller 102 such that data may be transmitted over an ethernet cable 104 having a distance greater than 100 meters.

FIGS. 7-18 describes an alternative embodiment that might be used for protecting a protected area 608 for an alternative architecture within chips including a CPU rather than chips that do not have a CPU as in the previous embodiment. Referring now to FIG. 7, there is illustrated a diagram of the flash operation with a flash controller 702. The flash 212 is interfaced with the flash controller 702 which is basically operable to control all operations of the flash 212. The EMIF interface 406 is operable to interface with the flash controller 702 through an internal databus 704, address bus 706 and control bus 708. The interface 406 is operable to receive and latch the address in a multiplex mode, onto the address bus 706 and then receive the data and latch that data onto the databus 704. The various control functions to control reading, writing and the such, are provided on the control bus 708. By writing data into particular flash control registers in the flash controller 702, the operation of the flash 212 can be controlled. These utilize a separate address bus 712, databus 714 and control bus 716 between the flash 112 and the flash controller 702. As such, it can be seen that the external device can, through the EMIF memory interface 406 and in addition to communicating with the network, communicate with the flash 212 and actually occupy a portion of the flash memory space, i.e., the flash 212 becomes extended memory for the microcontroller.

Referring now to FIG. 8, there is illustrated a diagrammatic view of the memory map for the entire controller 102. In general, the controller 102, in addition to the flash 212, as the other various registers, FIFO, RAM, interrupt registers, etc., for storing information therein. Each of the storage locations is addressable in the address space or memory space of the controller 102. The flash 212 is mapped into this space and occupies a portion of the address space 802 and includes the protected portion 608. There is also provided configuration information, occupying a portion of the memory space 804, which is at the top of the memory. Whenever the part is powered-up, it will automatically go to this portion of the memory space and extract the data therefrom for the purpose of power-up, and running various calibration operations. The flash space 802 will contain some of the configuration information, which will be downloaded to the configuration memory space 804 for the purpose of configuration. Also, the interrupt registers are disposed in the memory space at locations 806 and 808.

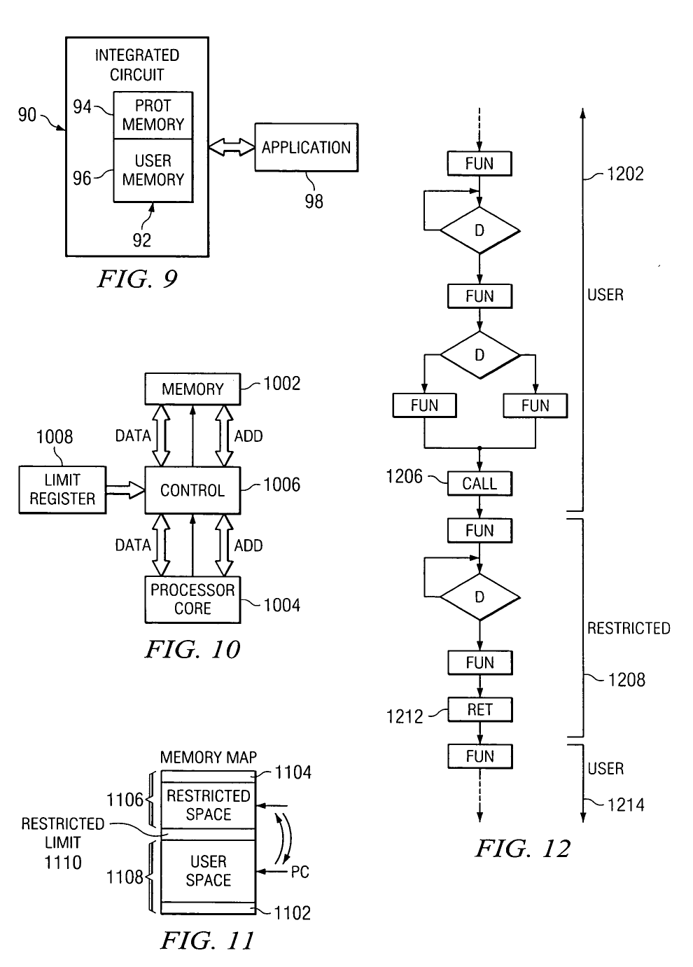

Referring now to FIG. 9, there is illustrated a top level diagram of a system utilizing the protected memory area described with respect to FIG. 6. An integrated circuit 910 is provided which has disposed therein a protected memory 912. The protected memory 912 has associated therewith a protected memory region 914 and a user memory region 916. The integrated circuit 910 can be interfaced to any type of application 918 which can be any type of integrated circuit or board level device that interfaces with the integrated circuit 910. This integrated circuit 910 could be a part of a PC board which includes other integrated circuits or it could be a stand-alone integrated circuit that contains substantially all functionality needed to interface with the application 918. As will be described herein below, the protected memory region 914 contains proprietary instructions that can be executed under the control of the user memory region 916. However, the user cannot, through program instructions stored in the user memory section 916, access information in the protected memory region 914 for retrieval therefrom for the purpose of viewing the instruction code or even the data stored in the protected memory region 914.

Referring now to FIG. 10, there is illustrated a block diagram of the interface between a memory block 1002 and a processor core 1004. The processor core 1004 contains general processing architecture and is operable to generate addresses, receive data, generate various control functions, etc. Typically, this will contain a Program Counter for substantially stepping through various instructions that are retrieved from the memory 1002. A control logic block 1006 is disposed between the processor core 1004 and the memory 1002, this having associated therewith the various logic function to achieve the protected memory function described herein below. The control logic block 1006 is operable to interpret addresses received from the processor core 1004 and compare them with information stored in a limit register 1008. This limit register 1008 is either mask programmed or it is electronically programmed as a Write-Once, Read-Many (WORM) memory that allows a limit to be input to the integrated circuit 910, which limit defines the boundary between the protected memory region 914 and the user memory region 916. The control logic block 1006, as will be described further herein below, is operable to monitor the contents of the address bus and determine whether the contents of the address bus are directed toward the operation of fetching data or attempting to fetch an instruction code, i.e., whether the contents of the address bus constitute the contents of the Program Counter. With this information, the control logic block can then determine whether access is to be allowed to the memory 1002. If not, some type of inhibit or other protected operation is undertaken.

Referring now to FIG. 11, there is illustrated a diagrammatic view of a memory map for the memory 1002. The memory 1002, as is conventional, is comprised of a plurality of memory locations which are accessible by generating an address. When the address is generated, a plurality of memory locations are accessed which typically constitute a “byte” of data, although any length is anticipated. For each address generated, one byte of data will be output. The memory map of FIG. 11 represents a sequence of byte locations from a lower byte location 1102 to an upper byte location 1104. The memory is divided into a restricted space and a user space, the restricted space comprising memory locations 1106 and the user space comprising memory locations 1108. There is one addressable memory location, memory location 1110, which constitutes the boundary memory location. The address of this boundary location constitutes an address that is in the restricted space 1106 and which address comprises the “limit” for the operation, as will be described in more detail herein below.

The Program Counter (PC) is basically a pointer that defines an address for a particular instruction to be carried out. When this Program Counter address is generated, it is placed onto the address bus and the information at that address location extracted therefrom and routed to the processor core 1004 for operations thereon. In the execution of the various instructions, the Program Counter may actually jump from the user space 1108 up the restricted space 1106 to execute instructions therein. This is allowed in accordance with the embodiment herein to facilitate executing instructions in the restricted space 1106 in response to a “call” instruction executed in the user space 1108. However, as will be further described herein below, instructions in the user space 1108 cannot generate an address for the purpose of reading data from the restricted space 1106 which would allow output of information stored in the restricted space from the system. The protective operation described herein is operable to prevent such an operation from occurring.

Referring now to FIG. 12, there is illustrated an exemplary flowchart that depicts operation of the system wherein the instructions jump between the user space and the restricted space. In the first portion 1202, the flowchart is executed along a flow path which has inserted therein a “Call” instruction in a block 1206. At this instruction, the program is instructed to jump to the restricted space 1106 by changing the value of the Program Counter (PC) and execute instructions therein in accordance with the new value of the PC. These blocks in the flowchart are a combination of various function blocks “Fun” and decision blocks “D.” When the Call instruction is incurred at the block 1206, the program will jump to the restricted space, represented by region 1208. Of course, the Call instruction 1206 must have associated therewith an Operand that has a Program Counter value associated with an addressable location within the restricted space 1106. Once in the restricted space at the jumped-to location, the program will begin execution therefrom. This is represented by the various operational blocks in the program within the region 1208. Once all the instructions have been executed in the restricted space associated with the jumped-to location, there will be an instruction at the end of the executable portion representing a return to the user space, indicated by a function block 1212. This will then result in the Program Counter being returned back to the user space, typically at the next sequential Program Counter value as that associated with the Call instruction 1206. The program will then continue in the user space, as represented by a portion 1214 of the flowchart.

By executing instructions in the user portion 1202 or the user portion 1214 of the flowchart, the protective circuitry, as will be described herein below, prohibits any instructions from accessing an addressable location within the restricted space 1106 for reading of information therein or writing of information thereto. This is facilitated by examining the contents of the address bus and determining whether the contents of the address bus constitute an address for the purpose of reading or writing data or they constitute a Program Counter value for the purpose of executing an instruction. If the program is operating in the user space and the information placed on the address bus is that of an address, as opposed to a Program Counter value, then the system is restricted. However, once the program is jumped over to the restricted space 1208 through the incrementing of the Program Counter to an addressable location within the restricted space and placing of that Program Counter value on the address bus, then the operation will be transferred to the restricted space. Once in the restricted space, the program in the restricted space is capable of reading information from an addressable location anywhere in the memory and writing information thereto. This, of course, will be under the control of proprietary software and not under the control of user-generated software in the user space 1108.

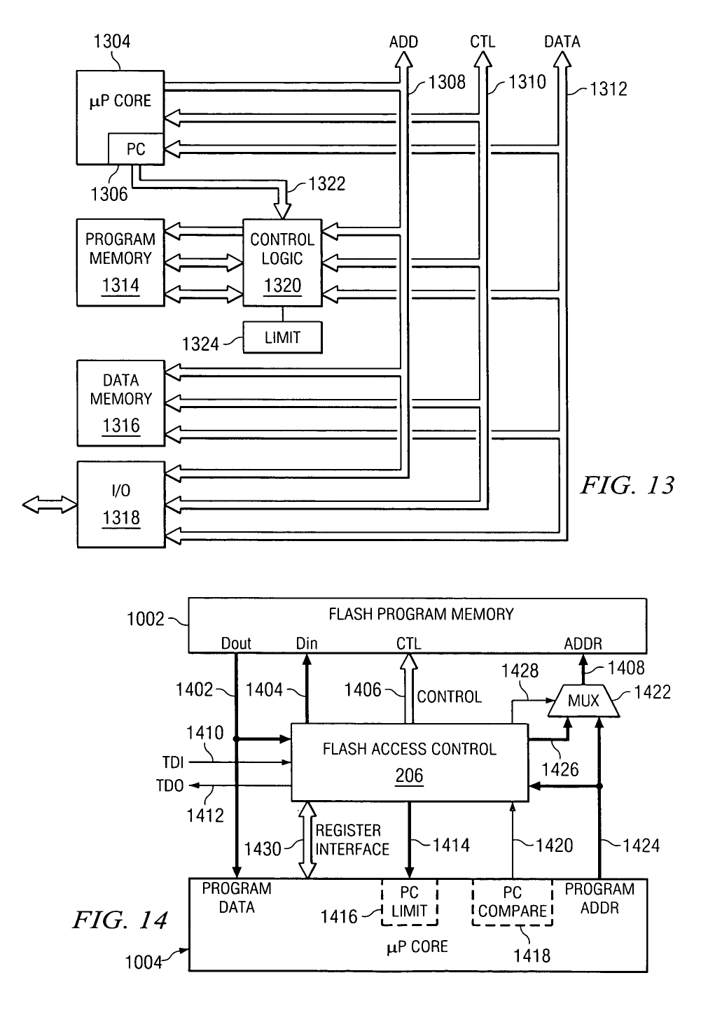

Referring now to FIG. 13, there is illustrated a block diagram of an integrated circuit 910 incorporating the protected memory. A microprocessor core 1304 is provided having a Program Counter 1306 associated therewith. The microprocessor core 1304 is interfaced with an address bus 1308, a control bus 1310 and a data bus 1312. There is also provided a program memory 1314, the protected memory in the system, and a data memory 1316. The data memory 1316 can be any type of memory, a volatile memory or a non-volatile memory, for storing readily accessible data in the such. There is also provided an input/output interface block 1318 which is operable to interface external circuitry with the buses 1308-1312. The program memory 1314 and the data memory 1316 are also interfaced with the buses 1308-1312. However, the memory 1314, the protected memory, is interfaced with the buses 1308-1312 through a control logic block 1320. This control logic block 1320 is operable to examine both the address information on the address bus 1308 and also the information in the Program Counter (or information relating thereto), which is interfaced therewith, through a Program Counter bus 1322. Of course, it should be understood that some of this control logic 1320 could be incorporated into the microprocessor core 1304 and merely the results of a comparison operation provided as a limited value output. The control logic block 1320 is interfaced with a limit register 1324, which is similar to the limit register 1008 in that it contains information regarding the addressable location of the output between the restricted space 1106 and the user space 1108, this essentially being the address of the limit location 11 10. However, it should be understood that multiple limits could be provided within the restricted space providing different restricted spaces. It is merely noted that the control logic block 1320 is operable to monitor the operation of the system and determine whether access to the memory 1314 is to be allowed when this address is generated. This is based upon various considerations, as will be discussed herein below.

The control logic block 1320 is operable, when a determination is made that access is to be prohibited, to take one of a number of actions. One action could be to actually inhibit the address from being routed to the memory 914; one action could be to alter the address such that the desired location is not actually addressed, but the address is forced to the unrestricted space. Another action could be to inhibit output of data during that time or to output a preset data value such as an eight bit value of 00.sub.h. A further action is to inhibit the control circuitry feeding the memory. Each of these different alternatives will be described herein below. However, it should be understood that any manner of preventing access to information within the memory, once it has been determined that access to the restricted space is to be denied, would be anticipated by the present disclosure.

In order to describe how the system operates with respect to the Program Counter and the contents of the address register which can selectively be placed on the address bus, reference is made to the following Table 1.

TABLE 1

| MEM | PC | BUS | BUS CONTENT |
|---|---|---|---|
| (OPCODE) | MOVEC | 0001.sub.h | 0001.sub.h PC Value |
| (OPERAND) | CD.sub.h | 0002.sub.h | 0002.sub.h PC Value |
| (DATA) | FC.sub.h | xxxx | 00CD.sub.h ADDR-Allowed |

. . . . .
. . . . .
. . . . .

| | | | |
|---|---|---|---|
| (OPCODE) | LJMP | 00F1.sub.h | 00F1.sub.h PC Value |
| (OPERAND) | FE.sub.h | 00F2.sub.h | 00F2.sub.h PC Value |
| (OPERAND) | FE.sub.h | 00F3.sub.h | 00F3.sub.h PC Value |
| (OPCODE) | PUSH | FEFE.sub.h | FEFE.sub.h PC Value |

. . . . .
. . . . .
. . . . .

| | | | |
|---|---|---|---|
| (OPCODE) | MOVEC | FEFE.sub.h | FEFE.sub.h PC Value |
| (OPERAND) | FF.sub.h | FEFF.sub.h | FEFF.sub.h PC Value |
| (OPERAND) | FF.sub.h | FF00.sub.h | FF00.sub.h PC Value |
| (DATA) | C2.sub.h | xxxx | FFFF.sub.h ADDR-Allowed |

. . . . .
. . . . .
. . . . .

| | | | |
|---|---|---|---|
| (OPCODE) | MOVEC | 00FE.sub.h | 00FE.sub.h PC Value |
| (OPERAND) | FF.sub.h | FEFF.sub.h | COFF.sub.h PC Value |
| (OPERAND) | FF.sub.h | C000.sub.h | C000.sub.h PC Value |
| (DATA) | C2.sub.h | xxxx | FFFF.sub.h ADDR-Not |
| | | Allowed | |

In Table 1, it can be seen that there is provided the content of the memory location being addressed, the value of the Program Counter, the value actually placed on the address bus and the contents of the address bus. In the first line, the Program Counter is initiated at a value of 0001.sub.h representing the first instructions which are initiated at the first location in the memory. By example, this is a move command which is operable to control information to the access from the memory and move to a register, such an accumulator or another location. This is referred to as the command “MOVEC.” This constitutes the Opcode. The second part of the instruction will be the Operand, which, in this instance, will be output when the Program Counter changes to 0002.sub.h. This results in the eight-bit value CD.sub.h being output on the address bus in the next operation. Therefore, for the first two steps, it can be seen that the Program Counter value can be placed onto the address bus for the purpose of addressing the memory. The eight-bit Operand CD.sub.h constitutes an operation wherein this eight-bit value is appended onto another value, in this example, an eight-bit value of 00.sub.h to result in the overall address value of 00CD.sub.h. At this point in time, the address bus value is an address value that is output from an address register and, therefore, the contents of the Program Counter are a “don't care.” As the instructions continue, the Program Counter will be incremented up to or jumped to a value of 00F1.sub.h. The Opcode in the memory will be a long jump command, LJMP, which requires both the high and low address values to the output over the next two increments of the Program Counter. The first address will be a PC counter value of 00F2.sub.h at the value of FE.sub.h, and the next Program Counter increment of 00F3.sub.h will result in an Operand of FE.sub.h being output. These two Operands are assembled as the high and low portions of the memory address and placed into the Program Register as an address FEFE.sub.h. This constitutes a new Program Counter value which is then the subject of some command in the memory, a PUSH command in this example, although it could be any type of command, the result of the overall LJMP operation being to increment the Program Counter the value FEFE.sub.h to execute this command.

To illustrate the operation wherein a data move command is allowed within the restricted space, a third section of the code is illustrated. This is initiated at a program counter value of FEFE.sub.h as a MOVEC command. This is operable to, on the next two increments of the program counter to FEFF.sub.h and FF00.sub.h, respectively, to output the two operands FF.sub.h and FF.sub.h. This results in an address value of FFFF.sub.h being placed onto the address bus to extract data from that location in the restricted space, wherein the boundary between the restricted space and the user space is the address F000.sub.h. The system will examine the fact that the PC value on the previous operand was within the restricted space, but that it was an allowed operation, since the instruction originated within the restricted space due to the fact that the program counter exists in the restricted space.

In a fourth section of the code, originating with a MOVEC command at an address of 00FE.sub.h Program Counter value, an address attempt is made to the address location FFFF.sub.h. If the limit between the restricted and user space is an address location of F000.sub.h, then this would indicate that a command originating in the user location 00FE.sub.h was trying to attempt to place an address on the address bus that was in the restricted area, i.e., attempting to extract data therefrom. It can be seen by comparison of the last two sections of the code, that an instruction originating in the restricted space accessing information in the restricted space (or even in the user space) is allowed, wherein access to information in the restricted space in response to an instruction from the user space is not allowed.

In the operation described in Table 1, a decision would be made at the point that the commands in the memory would result in an address being placed onto the address bus. It is at this point in time that the system examines the location within the memory of the Program Counter, and then also looks at the address to determine whether the address is seeking to address information within the user space or the restricted space. As described herein above and as will be further described herein below in more detail, if the Program Counter is in user space, addressing information in restricted space for the purpose of outputting this information or examining the contents thereof will be prohibited. Alternatively, if the Program Counter is within the restricted space, i.e., executing instructions of a proprietary nature to the chip vendor, then addressing within the restricted space or the user space will be permitted.

Referring now to FIG. 14, there is illustrated a more detailed block diagram of the embodiment of FIG. 10, wherein like numerals refer to like parts in the various figures. The memory 1002 is realized with a flash memory, which has a data output port, Dout, interfaced with data output bus 1402 and a data input port, Din, interfaced with a data input bus 1404. There is also provided a control input CTL, which receives controls from a control bus 1406. The address is received on an address input via an address bus 1408. The control device 1006 is comprised of a flash access control which is operable to interface with a TDI input bus 1410, a serial bus, and provide data output on a TDO serial output bus 1412. The control 1006 also is interfaced with the data bus 1402 such that the output by the memory 1002 can be received thereby.

The control device 1006 is operable to store the limit information and provide that on a bus 1414 to the microprocessor core 1004 as the Program Counter limit, represented by a phantom block 1416. Internal to the microprocessor core 1004, in one embodiment, the comparison operation compares the actual value of the Program Counter with the PC limit in phantom block 1416. This is output by an phantom block 1418 which is labeled “PC Compare.” This is output as a signal on a signal line 1420 to the control block 1006.

The control block 1006 is operable to interface with, and include as part thereof, an address modifying the circuit, which is comprised in this example of multiplexer 1422. The multiplexer 1422 is operable to receive a portion of the address on an address bus 1424, which address is also input to the control block 1006, this operation described in more detail herein below. This portion of the address can be modified and output to the multiplexer on a bus 1426. The multiplexer 1422 is controlled by a control line 1428 such that the multiplexer can output the full address on bus 1424 or a modified address on a bus 1426. This modified address basically is operable to inhibit address input to the memory 1002 when it is determined that this address is the result of a program instruction that is attempting to download or move data from the restricted portion of the memory space when the instruction code is derived from the user portion of the memory space. During operation of the memory 1002, when program instructions are extracted from the memory 1002 in response to a Program Counter value as an address being placed on the address bus 1424, then program data will be output on the output bus 1402 into a program data input on microprocessor 1004 via the data bus 1402. Further, there is provided a register interface 1430 between the control block 1006 and the microprocessor core 1004. This is a flash access control function provided by the control block 1006 and is generally a conventional access to a flash memory. Serial data can be input to the flash memory via the input bus 1410 and data read therefrom for the purpose of programming the memory initially and for programming instruction registers in the control block 1006, this being a configuration operation—a conventional operation.

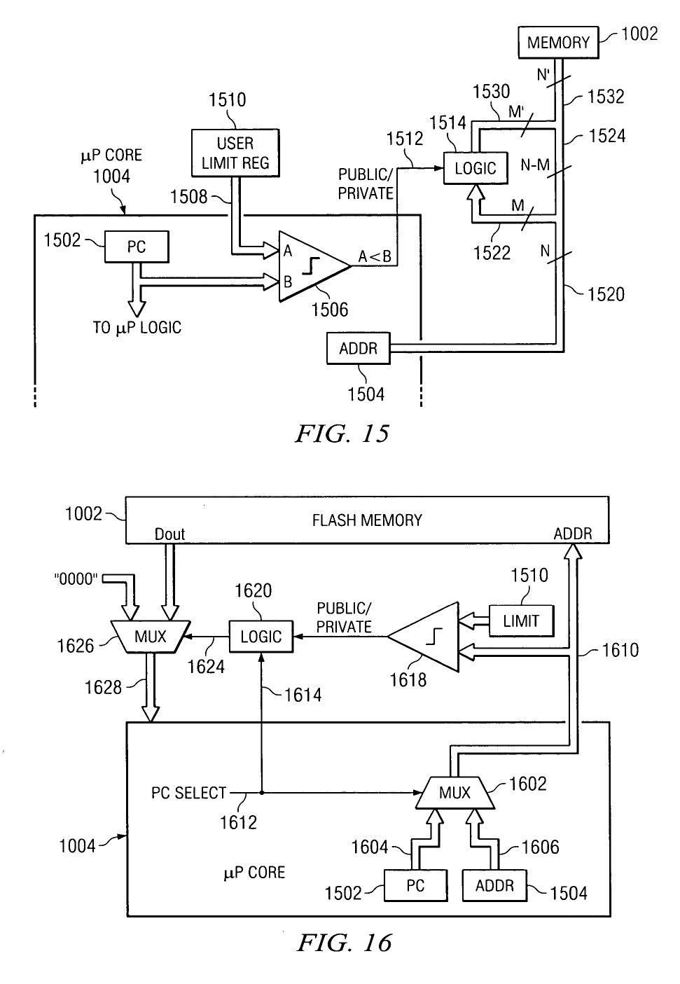

Referring now to FIG. 15, there is illustrated a detailed block diagram of one embodiment for restricting access. The microprocessor core 1004 has contained therein, in a simplified illustration, a Program Counter 1502 and an address register 1504. The Program Counter 1502 is operable to output a count value for programming instructions that will be provided it to the microprocessor logic and also provided to a comparator 1506. The comparator 1506 is also operable to interface through a bus 1508 to a user limit register 1510, this typically in the control block 1006. However, this could be a limit that could be hard wired into the microprocessor core 1004 or in a completely separate register in the core 1004. This could even be a register within the flash memory 1002 that is accessible by a certain sequence of program instructions. In any event, once loaded, this limit is unalterable by the user and, in some situations, by the actual vendor themselves.

The comparator 1506 is operable to compare the value of the Program Counter with the value in the user limit register. In this manner, the comparator will provide an output on a signal line 1512 which will indicate whether the Program Counter is in the restricted or in the user space with a public/private signal. This signal line 1512 is input to logic block 1514.

The address register 1504 in the microprocessor 1004 is output on an address bus 1520, which has a width of N. This bus has a portion of the bits thereof extracted therefrom, there being M bits extracted therefrom on a bus 1522. Therefore, the bus 1520 is divided into a bus 1522 with M bus lines and a bus 1524 with N-M bus lines. The bus 1522 is input to a logic block 1514, this typically representing the upper block of memory. If there is no inhibit operation on the memory 1002 to be performed due to an attempt to access data in the restricted space while operating the program in the user space, then the logic 1514 will pass the received bits on the bus 1522 out onto a bus 1530 to be combined with the bus 1524 on a bus 1532. The bus 1530 provides the bits M′ wherein the bus 1532 provides bits N′. This represents a situation wherein the bus may actually be modified by having the upper block altered. Typically, the upper block of memory addressing bits, the M bits, will be altered in the event of a positive decision on the signal line 1512 that the Program Counter 1502 is operating in the public area and the address output thereof is from the address register 1504 and is addressing information in the private area. It should be understood that this example illustrates an address from the address register 1504 where, in program situations, the information on the address bus 1520 is from the Program Counter 1502. This is not illustrated for simplicity purposes. However, the conduct of the address bus 1520 is typically selected by a multiplexer (not shown) that selects either the output of the address register 1504 or the output Program Counter 1502.

Referring now to FIGURE. 16, there is illustrated a block diagram of an alternate embodiment for inhibiting access to the memory 1002 whenever an instruction executed in the user space attempts to access data in the restricted space, it being understood that a jump to a program instruction in the restricted space is allowed from the user space. In the microprocessor core 1004, there is provided a multiplexer 1602 that is operable to interface between the address register 1504 and the Program Counter 1502. The Program Counter 1502 provides an output therefrom on a bus 1604 to one input of the multiplexer 1602, whereas the output of the address register is input to the other input of the multiplexer 1602 through a second bus 1606. The output of the multiplexer comprises an address bus output that is connected to an address bus 1610 that is connected to the address input of the memory 1002. The multiplexer 1602 receives a PC select signal on an internal line 1612 within the microprocessor core 1004. This also is a conventional output provided by the microprocessor core 204 on a signal line 1614. This line 1614 indicates whether the PC register 1502 is selected or the address register 1504 is selected.

The contents of the address bus 1610 are compared with that of the user limit register 1510 with a comparator 1618. This comparator 1618 determines whether the address is in the public or private region of the address space, i.e., the user or restricted space, respectively. The output of this comparison operation is input to a logic block 1620 which also receives the signal on the signal line 1614. This logic block 1620 provides an output indicating a positive decision whenever it is determined that the contents of the PC register 1502 are not output on the bus 1610, i.e., the contents of the address register 1504 output on the address bus 1610 and that the address is above the limit in the limit register 1510. This positive result indicates an unauthorized attempt to access the memory 1002 in the restricted space. A signal is output on a line 1624 to a multiplexer 1626, which multiplexer 1626 will select either the data output of the memory 1002 or a value of 0000.sub.h, a “null” value. For a positive result, the null value is selected for input to the memory 1004 on the program data input via a bus 1628. Logic block 1620, in the alternate operational mode in the restricted space, can determine that the Program Counter value is selected for output on the bus 1610 and that the Program Counter value is in the restricted address space. This indicates a program instruction that is generated by the program in the restricted space. This is latched by the logic block 1620, since the comparator 1618 will indicate this as being in the private region. Therefore, an indication on the line 1614 that the Program Counter 1502 is selected by the multiplexer 1602 and that the information on the address bus 1610 is in the private or restricted space is latched such that, if a subsequent instruction indicates that the contents of the address register 1504 are selected, i.e., the signal line 1614 indicates that the address register is selected, and that the address is attempting to address information in the memory 1002, this will be allowed due to the fact that the previous program instruction was generated by program instructions in the restricted space.

A Verilog output is provided representing the operation wherein access to data in the memory with an address that is greater than the read limit resulting from the program instruction executed in the reader space:

wire addr_gt_readlimit = (mem_addr > {4′h7, read-limit, 4′hf});
always @ (posedge clk or posedge rst)

if (rst)

user_code_executing <= 0;

else if (pc_valid)

user_code_executing <= addr_gt_readlimit;

assign read_limit_exceeded = core-reset & suspend // uP access that
is

| | |
|---|---|
| mem_psenb & | // a read cycle, by |

| | |
|---|---|
| user_code_executing & | // user code that |

is not

| | |
|---|---|
| pc_valid & | // an instruction |

fetch

addr_gt_readlimit;

*--------------------------------mem_rdata
Mux--------------------------------*/
//
// if either a S/W read access exceeds the “read_limit” or the JTAG port
// trys to read a “read_locked” region - the security H/W will mux ZEROs
// onto the “security_dout” bus
//
assign security_dout = read_limit_exceeded

| | |
|---|---|
| ?8′h00 | // output all zeros |

| | |
|---|---|
| :dout; | // read data from flash |

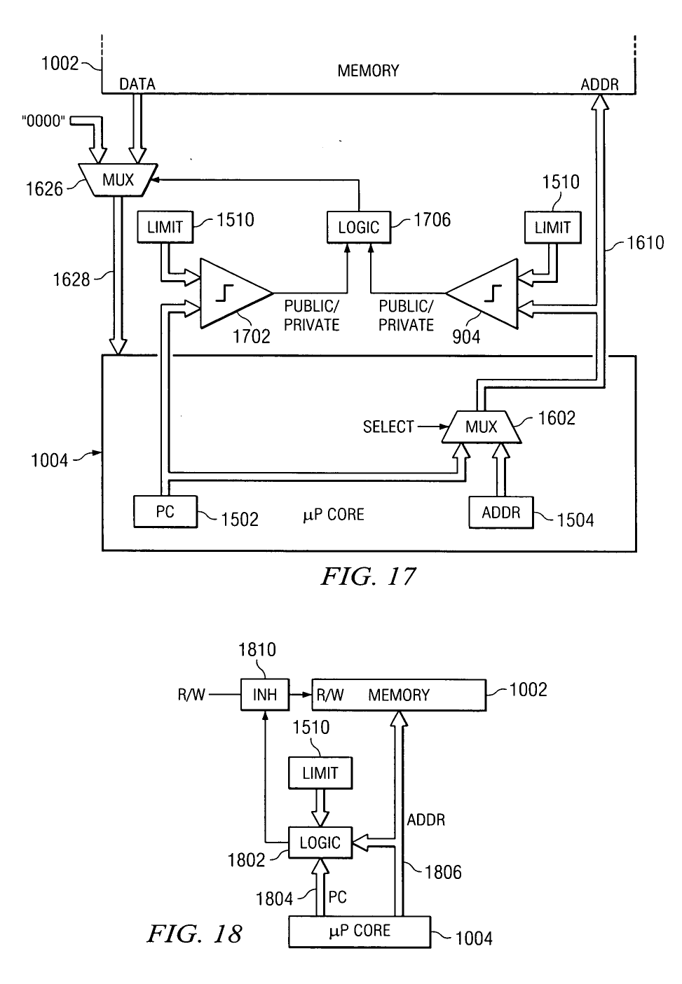

Referring now to FIG. 17, there is illustrated a block diagram of an alternate embodiment. In the embodiment of FIGURE. 17, the contents of the Program Counter 1502 are output to a comparator 1702 which compares the information thereof with the contents of the limit register 1510 to determine if the Program Counter value is in a public or private region. Similarly, the contents of the address bus 1610 are compared with a comparator 1704 with a limit in the limit register 1510. The limit register 1510 is illustrated as two registers for simplicity purposes, to determine if the contents of the address register are in the public or private region. The output of both comparators 1702 and 1704 are input to the logic block 1706. Logic block 1706 determines whether the Program Counter is in the private or public area and also determines whether the information in the address bus 1610 is in the public or private area. If it is determined that the Program Counter 1502 is operating in the private area and that the information in the address bus 1610 is operating in the private area, then the multiplexer will allow data to flow therethrough, since the logic block 1706 can determine that the address is the result of a previous Program Counter instruction in the private area or restricted area. However, when it is determined that the Program Counter is in the public area, the user area, and the address is an address value from address register 1504 and this is in the restricted or private area, then the logic block 1706 will control the multiplexer to select the null value.

Referring now to FIG. 18, there is illustrated a view of an alternate embodiment for inhibiting the memory operation. In this simplified embodiment, there is provided a control block or logic block 1802 that is operable to receive the output of the Program Counter on a bus 1804 and the address bus on an address bus 1806. The logic block 1802 compares this with information in the limit register 1510 to determine what type of operation is being performed, i.e., a program instruction or a memory access instruction, and where in the memory map the address resides. This was described herein above. In this embodiment, there is provided an inhibit circuit 1810 that is operable to inhibit a read/write operation to memory 1002 in the event that the logic block 1802 makes a determination that this is a restricted operation.

Although the preferred, embodiment has been described in detail, it should be understood that various changes, substitutions and alterations can be made therein without departing from the spirit and scope of the invention as defined by the appended claims.

What is claimed is:

1. An ethernet controller, comprising:
analog circuitry for generating a transmit waveform representing transmitted data responsive to a digital control signal;
digital circuitry for generating the digital control signal, wherein the digital control signal is programable to enable amplification of the transmit waveform.

2. The ethernet controller of claim 1, wherein the digital circuitry further includes a memory including a storage location for storing the digital control signal for controlling generation of the transmit waveform at a selected amplitude.

3. The ethernet controller of claim 2, wherein the digital control signal associated with the transmit waveform enables the transmit waveform to be transmitted over a selected length ethernet cable.

4. The ethernet controller of claim 2, wherein the memory comprises a flash memory.

5. The ethernet controller of claim 4, further including a protected area in the flash memory for storing the digital control signal.

6. The ethernet controller of claim 4, further including a RAM memory, wherein the digital control signal is loaded into the RAM memory from the flash memory during power up.

7. The ethernet controller of claim 6, further including a power up detecter for loading the digital control signal during power up.

8. The ethernet controller of claim 1, wherein the analog circuitry includes an IDAC for generating the transmit waveform responsive to the digital control signal.

9. An ethernet transmitter, comprising:
analog circuitry for generating a transmit waveform representing transmitted data responsive to a digital control signal, the analog circuitry including:
an IDAC for generating the transmit waveform responsive to the digital control signal;
digital circuitry for generating the digital control signal, wherein the digital control signal is programable to enable amplification of the transmit waveform, the digital circuitry including:
a random access memory including a configuration location for storing the digital control signal for controlling generation of the transmit waveform at a selected amplitude;
a flash memory including a protected area for storing the digital control signal, wherein the digital control signal is loaded from the protected area to the configuration location of the random access memory during power up.

10. The ethernet controller of claim 6, further including a power up detecter for loading the digital control signal during power up.

11. The ethernet controller of claim 9, wherein the digital control signal associated with the transmit waveform enables the transmit waveform to be transmitted over a selected length ethernet cable.

12. An ethernet network, comprising:
an ethernet receiver for receiving a transmit waveform;
an ethernet cable for providing the transmit waveform to the ethernet receiver; and
an ethernet transmitter for transmitting the transmit waveform, wherein an amplitude of the transmit waveform is programmable based upon a length of the ethernet cable interconnecting the ethernet receiver to the ethernet transmitter.

13. The ethernet network of claim 12, wherein the ethernet transmitter further comprising:
analog circuitry for generating a transmit waveform representing transmitted data responsive to a digital control signal;
digital circuitry for generating the digital control signal, wherein the digital control signal is programable to enable amplification of the transmit waveform.

14. The ethernet network of claim 3, wherein the digital circuitry further includes a memory including a storage location for storing the digital control signal for controlling generation of the transmit waveform at a selected amplitude.

15. The ethernet controller of claim 14, wherein the digital control signal is associated with the transmit waveform enables the transmit waveform to be transmitted over a selected length ethernet cable.

16. The ethernet controller of claim 15, further including a protected area in the flash memory for storing the digital control signal.

17. The ethernet controller of claim 14, further including a RAM memory, wherein the digital control signal is loaded into the RAM memory from the flash memory during power up.

18. The ethernet controller of claim 17, further including a power up detecter for loading the digital control signal during power up.

19. The ethernet controller of claim 13, wherein the analog circuitry includes an IDAC for generating the transmit waveform responsive to the digital control signal.

20. A method for programing an amplitude of a transmit waveform in an ethernet network, comprising the steps of:
determining a length of an ethernet cable connecting an ethernet transmitter to an ethernet receiver;
selecting digital control data based upon the determined length of the ethernet cable for generating a transmit waveform;
storing the digital control data in a memory; and
generating the transmit waveform from the digital control data.

21. The method of claim 20, wherein the step of storing further comprising the step of storing the digital control data in a protected area of FLASH memory.

22. The method of claim 21, wherein the step of generating further comprises the step of:
detecting power-up of the transmitter;
loading the digital control data from the protected area of FLASH memory to RAM memory;
forwarding the digital control data to an analog circuit.
